(19) United States
(12) Patent Application Publication
(10) Pub. No.: US 2010/0190661 A1
(43) Pub. Date: Jul. 29, 2010

(54) SERS-ACTIVE STRUCTURE FOR USE IN RAMAN SPECTROSCOPY

(75) Inventors: Shuit-Tong Lee, Hong Kong SAR (CN); Ning Bew Wong, Hong Kong SAR (CN); Ming-Liang Zhang, Hong Kong SAR (CN); Meng-Su Yang, Hong Kong SAR (CN); Ming-Wang Shao, Suzhou (CN)

Correspondence Address: LEYDIG VOIT & MAYER, LTD, 700 THIRTEENTH ST. NW, SUITE 300, WASHINGTON, DC, 20005-3960, US

(73) Assignee: CITY UNIVERSITY OF HONG KONG, Kowloon Tong (HK)

(21) Appl. No.: 12/359,401

(22) Filed: Jan. 26, 2009

(51) Int. Cl. C40B 40/10

(52) U.S. Cl. 506/18; 977/954

(57) ABSTRACT

A surface-enhanced Raman spectroscopy (SERS)—active structure for use in Raman scattering detection has an array of nanostructures formed on a substrate by deposition and chemical etching. The nanostructures are coated with metal nanoparticles.

### FIELD OF THE INVENTION

The present invention relates to surface enhanced Raman spectroscopy (SERS). More particularly, the invention relates to SERS—active structures for use in Raman Scattering detection.

### BACKGROUND OF THE INVENTION

The scattered light associated to vibration energy levels of the molecule founds the principle of Raman spectroscopy, so it is a fingerprint of the molecule. Conventional Raman scattering has small cross section and requires large number of molecules or strong incident light to give adequate signals. The proposal of surface-enhanced Raman spectroscopy (SERS) led to renewed interest in the exploration of Raman spectroscopy for ultra-sensitive analysis. SERS has many merits in bio-analytical applications, for example, in immunoassay readout. The common SERS substrates are silver and gold nanoparticles in colloidal solution or film. Nanoparticle fabricated from chemical reduction, whose surfaces were usually terminated with organics, have a serious influence in ultra-sensitive detection. Nanoparticles can also be produced from physical evaporation have relatively clean surfaces, but they are unstable, difficult to be reproduced, and unsuitable for high-volume production.

### SUMMARY OF THE INVENTION

It is an object of the present invention is to provide a SERS—active structure for use in Raman Scattering detection that ameliorates the above mentioned problems, or that at least provide the public with a useful alternative.

There is disclosed herein a substrate for use in Raman scattering detection, the substrate comprising a nanoarray contained ordered nanowires or nanorods, nanoribbons, nanotubes, nanochains, nanocables, etc, and metal nanoparticles arranged on the surface of the nanowires or nanorods, nanoribbons, nanotubes, nanochains, nanocables, etc; said metal nanoparticles being of a material selected from the group comprising Au, Ag, Cu, Fe, Co, Ni, Ru, Rh, Pd, Pt or composites comprising some of them, such as AuₐAg_{b}, Au_{c}Ag_{d}Ptₑ, RuₓPd_{y}Pt_{z}.

The nanoarrays of nanowires, nanorods, nanoribbons, nanotubes, nanochains, nanocables, may be formed of inorganic (semiconductors, conductors, insulators),organic (small molecules, polymer) and biomolecules. For example the substrate may be formed from semiconductors including the main groups of IV, II-VI, III-V, and their complex compounds, such as C (carbon nanotube, diamond), Si, Ge, ZnO, ZnS, ZnSe, CdS, CdSe, BN, AlN, GaN, InP, GaAs SiC e.g.; also may be formed from conductors, such as Au, Ag, Al, Cu, Fe, Co, Ni, Ti, Cr and their composites.

### BRIEF DESCRIPTION OF THE DRAWINGS

The invention will now be described by way of example only with reference to the accompanying drawings in which:

FIG. 1 are scanning and transmission electron microscope images of a surface-enhanced Raman scattering active substrate according to the invention in which (a) is a top view of Silicon nanowires, (b) is a side view of the Silicon nanowires, (c) is a close-up of a Silver nanoparticle covered nanowire, and (d) is a high resolution view of the a part of the Silver nanoparticle covered nanowire,

FIG. 2 is a graph of Raman spectra of mIgG, gamIgG and their corresponding controls, and

FIG. 3 2 is a graph of SERS spectra of mIgG, gamIgG and their immunocomplex.

### DETAILED DESCRIPTION OF THE INVENTION

The present invention will be described in detail with reference to the drawings. The described embodiment consists of a silicon (Si) substrate with an array of Si nanowires formed on the substrate and coated with silver (Ag) nanoparticles. This is not however meant to limited the scope of the invention and the skilled addressee will appreciates that other materials may be used for the substrate, nanowires and nanoparticles including, but not limited to:
for the substrate: semiconductors groups IV, II-VI, III-V and their complex compounds, carbon, diamond, Si, Ge, ZnO, ZnS, ZnSe, CdS, CdSe, BN, AlN, GaN, InP, GaAs SiC,
for the nanoarray of nanostructures: as for the substrate as well as inorganic and organic semiconductors, conductors, insulators, molecules, polymer and bio-molecules, and
for the nanoparticles: Au, Ag, Cu, Fe, Co, Ni, Ru, Rh, Pd, Pt or their composites.

A preferred embodiment of a surface-enhanced Raman spectroscopy (SERS)—active substrate for use in Raman scattering detection according to the invention is formed by the following method. A substantially uniform array of silver (Ag) nanoparticles is formed on a n-Si(111) wafer using known deposition and chemical etching techniques. After washing, the n-Si(111) wafer is immersed in H₂SO₄ and H₂O₂ (v/v 3:1) solution to remove organics and form a thin oxide layer. The thin oxide layer is then removed by 5% hydrofluoric acid (HF) solution. The wafer is then immediately immersed into a solution containing HF (4.8M) and AgNO₃ (0.005M) to coat Ag nanoparticles. The wafer is then immersed to the etchant composed of HF (4.8M) and H₂O₂ (0.4M) for 30 minutes at room temperature. The remained Ag catalyst was dissolved by dilute HNO₃. After rinsing with 5% HF, it was placed in the solution containing HF (0.1M) and AgNO₃ (1×10⁻⁴M) at room temperature with uniform stirring. Silver nanoparticles were grown on every Si nanowire to form an Ag nanoparticle covered Si nanowire (nanoparticle covered nanowire) hierarchical array.

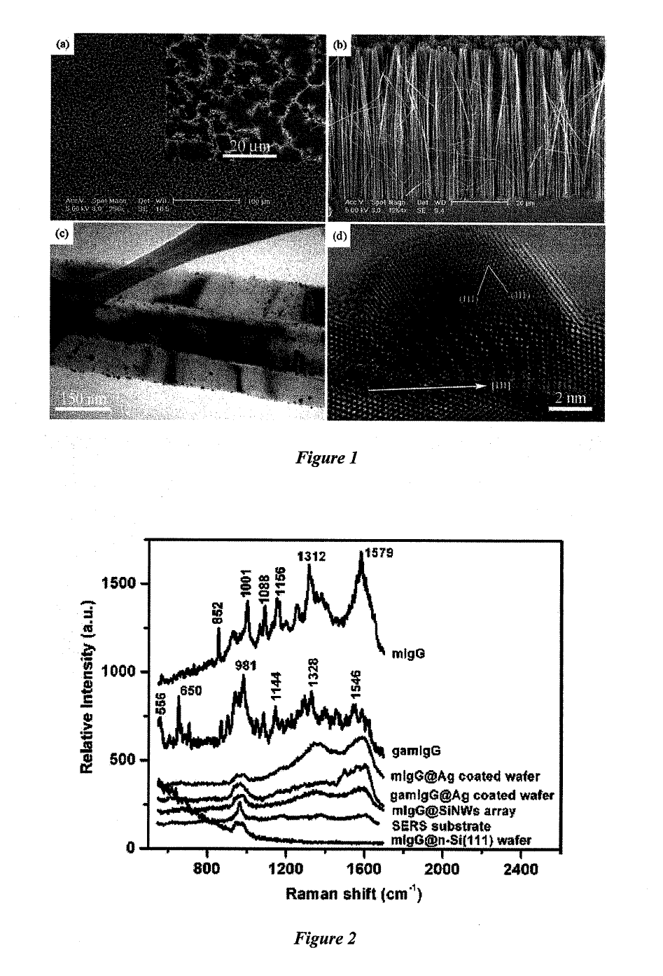

FIG. 1(a) is the top view scanning electron microscope (SEM) image of as-prepared Si nanowire array, in which the Si nanowires are uniform in large scale. The insert of FIG. 1(a) is a top view SEM image at high magnification, in which the Si nanowires are very clear and some of them congregate to form bundles. The diameters of Si nanowires is the range of 80-200 nm. FIG. 1(b) is a cross-sectional view of the as prepared Si nanowires array, in which the Si nanowires are distinguishable and most of them are vertical to the wafer surfaces. Some disordered Si nanowires arise from cutting and loading of SEM samples. The lengths of the Si nanowires are about 55 μm.

The transmission (TEM) image of nanoparticle covered nanoarray is shown in FIG. 1(c). The diameters of the Si nanowires are about 150 nm. The Ag nanoparticles cover the surfaces of Si nanowires in monolayer. The Si nanowires prepared from chemical etching have rough surfaces, indicating that the nucleation and growth of Ag nanoparticles are not uniform. So the diameters of Ag nanoparticles is distributed in a wide range from 4 to 25 nm. The high resolution TEM (HRTEM) image of a nanoparticle covered nanoarray is shown in FIG. 1(d). All cores of the Si nanowires are single crystals, but their surfaces are rough and partially covered by amorphous layers. Most of the Si nanowires on the n-Si(111) wafer have (111) direction, indicated by arrow, which agrees with the SEM result in FIG. 1(b), where the vertical direction is also [111]. The Ag nanoparticles shown in FIG. 1(d) possess a face-centered cubic structure and the distance between the {111} planes is about 2.36 Å. There exist some Moiré fringes (dark stripes between the Ag nanoparticles and Si nanowires) in the image, which indicate that the Ag nanoparticles are partly embedded in the Si nanowires.

The Raman scattering detection properties of the SERS—active structure is illustrated by the following examples.

Aqueous solutions with 2 μg/ml mouse immunoglobulin G (mIgG) and goat-anti-mouse immunoglobulin G (gamIgG), respectively, were placed on substrates and were then dried in the N₂ flow at room temperature. A Renishaw 2000 laser Raman microscope equipped 514.5 nm argon ion laser with about 2 μm spot size in diameter for excitation was used. The SERS spectra of mIgG, gamIgG, and the corresponding controls are shown in FIG. 2. The curve “mIgG@n-Si(111) wafer” is the Raman spectrum of 50 ng mIgG directly loaded on n-Si(111) wafer. The wide peak from 920 to 990 cm-1 comes from second-order Raman band of Si wafer. There is no peak contributed from the mIgG, which reveals that 50 ng mIgG on the Si wafer is not sufficient to give Raman signals. The label of “SERS substrate” is the blank spectrum of the substrate. The second-order Raman peak of crystal Si—Si vibration at 962 cm⁻¹ is sharp and strong, which is possibly induced by surface enhancement effect.

To investigate the role of Si nanowires array in this SERS—active structure, a substrate for comparison was prepared through annealing a 10 nm Ag film on a flat n-Si(111) wafer surface and to form Ag nanoparticles on it. Then 50 ng mIgG and 50 ng gamIgG were placed on these flat substrates, respectively. The corresponding Raman spectra are shown in FIG. 2 denoted with “mIgG@Ag coated wafer” and “gamIgG@Ag coated wafer.” Besides the second-order Si—Si Raman band, there are two broad peaks for mIgG at 1355 and 1593 cm⁻¹. But for gamIgG, there is only one broad peak at 1494-1611 cm⁻¹. They are signals of the analyses, but have no structural information. So Ag nanoparticles on the flat surface of Si wafer cannot effectively enhance Raman signals of mIgG and gamIgG and the Si nanowire array is necessary for the enhancement.

In FIG. 2, “mIgG@Si nanowires array” indicates the Raman spectrum of 50 ng mIgG loaded on the Si nanowires array without Ag nanoparticles. The spectrum is similar to that of the “mIgG@Ag coated wafer” in weaker intensity. So Si nanowire array without Ag nanoparticles is not capable to enhance Raman signals.

In FIG. 2, “mIgG” and “gamIgG” indicate the Raman spectra of 50 ng mIgG and 50 ng gamIgG on the nanoparticle covered nanoarray substrates, respectively. After drying, the mIgG and gamIgG are adsorbed on the substrate through —S—S—, —COO—, —NH₂, —OH, and —CO—NH— bonds. The frequencies of most SERS peaks and their assignments are proposed and listed in Table 1.

TABLE I
Proposed Assignment of the Raman peaks for mIgG, gamIgG, and their immunocomplexes.

| mIgG | Assignment | gamIgG | Assignment | immunocomplex | Assignment |
|---|---|---|---|---|---|
| 1579 | Trp, Tyr, ν(ring) | 1585 | Asp, Glu, C═O | 1610 | Amide I, Trp, Tyr |
| 1377 | Tyr | 1546 | Trp, Tyr, ν(ring) | 1580 | Trp, Tyr, Phe |
| 1312 | Trp, Tyr, ν(ring) | 1455 | Trp, δ(CH₂) | 1515 | His |
| 1251 | Trp, Tyr, Amide III | 1393 | Tyr | 1477 | Trp, Tyr, δ(CH₂) |
| 1156 | Tyr | 1328 | Trp, Tyr, ν(ring) | 1409 | Asp, Glu, C═O |
| 1088 | Trp, Tyr | 1290 | Tyr, Amide III | 1383 | Tyr, ν(ring) |
| 1062 | Trp | 1144 | Tyr | 1363 | Trp, ν(ring) |
| 1001 | Trp, Tyr | 1084 | Trp, Tyr | 1319 | Tyr, Trp, ν(ring) |
| 928 | Trp | 1046 | Trp | 1296 | Tyr, ν(ring) |
| 852 | Tyr | 981 | Trp, Tyr | 1281 | Tyr, δ(ring), Amide III |
| 565 | Trp, —S—S— | 942 | Trp | 1214 | Tyr, Trp, δ(ring) |
| | | 900 | Trp | 1166 | Tyr |
| | | 868 | Tyr | 1130 | Trp, Tyr |
| | | 705 | —C—S—, Trp | | |
| | | 650 | —C—S—, Tyr, Cys | | |
| | | 605 | Trp | | |
| | | 556 | —S—S— | | |

These assignments are based on the reports for amino acid, peptides, and proteins. From the Raman bands of mIgG and gamIgG, the main residues identified on the substrates are tryptophan (Trp), tyrosine (Tyr), aspartic acid (Asp), histidine (His), phenylalanine (Phe), and glutamic acid (Glu). However, the SERS positions are shifted and their intensities deviate from the reported results. Possible reasons are caused by the substrate effect to the protein structures.

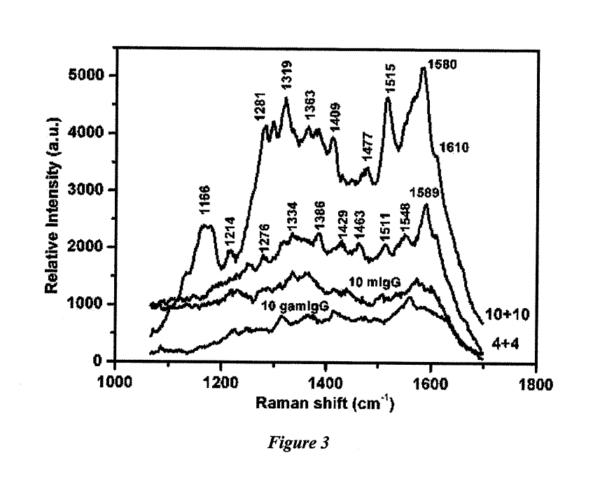

When 10 ng mIgG and gamIgG were loaded on the SERS substrates, only a few weak peaks appeared, as denoted by “10 mIgG” and “10 gamIgG” in FIG. 3, but it is insufficient to identify them. However, immunocomplex formed by 10 ng each of mIgG and gamIgG display strong Raman peaks, such as the “10+10” shown in FIG. 3. In comparing this spectrum with that of the “mIgG” and “gamIgG” in FIG. 2, peaks are different for the immuno-reagents and immunocomplex in the range from 1100 to 1700 cm⁻¹, which indicates the formation of immunocomplex. For instance, peaks at 1610, 1580, 1515, 1477, and 1409 cm⁻¹ appear in the spectrum of the immunocomplex but absent in that of the mIgG and gamIgG. The difference may be resulted from the conformational change after immune reaction. Amino acids residues, orientations of bonds, and functional groups attached to the surface of the substrate are different. Furthermore, the immunocomplex formed with 4 ng each of the mIgG and gamIgG on the nanoparticle covered nanoarray substrate, denoted by “4+4” shown in FIG. 3, still give distinct Raman peaks. The Raman bands of immunocomplex and immuno-reagents on our Raman substrates are quite different at high concentration. Moreover, even the amounts of immuno-reagents are insufficient to be detected; their immunocomplex can still give characteristic Raman signals. Hence, this kind of SERS substrate achieves an ultrahigh detection limit for immune reactions.

Two major effects are involved in the enhancement of Raman signal: electromagnetic effect associated with dipolar resonance occurring on the metal surface, and chemical effect from scattering process induced by chemical interaction between molecules and metal surfaces. In our detecting system, there present two kinds of Plasmon resonance: local resonance from every individual Ag nanoparticles and surface electromagnetic wave on the whole substrate surface. The former is similar to that in the colloidal system. In our substrate, the Ag nanoparticles periodically distribute on the whole surfaces of the Si nanowires array, and the Si can effectively transmit electromagnetic wave. So each individual electromagnetic wave produced from every Ag nanoparticles can spread, couple and resonate on the whole surfaces of the nanoparticle covered nanoarray, and achieve resonance effect. Meanwhile, the strength of Plasmon resonance on each individual Ag nanoparticles is coherently enhanced. This surface electromagnetic wave from all Ag nanoparticles may give a dominant contribution to enhance Raman scattering. On the other hand, the Ag nanoparticles are grown via redoc reaction at room temperature and their surfaces possess several active sites which can effectively bond the analyte molecules. Furthermore, the mIgG, gamIgG and their immunocomplex have many —S—S bonds, which is high affinity to the Ag surface and enhance the interaction between the bio-molecules and Ag nanoparticles. All these effects contribute chemical enhancement.

Large-area Si nanowires array has been prepared via chemical etching method and Ag nanoparticles were grown on the Si nanowires free from organic contamination. The nanoparticle covered nanoarray hierarchical array possesses strong surface enhancement effect. 50 ng mIgG or gamIgG on this substrate gives structural-dependent Raman bands and their immunocomplex formed with 4 ng mIgG and 4 ng gamIgG produce distinct Raman bands with shifted positions and changed intensities. This nanoparticle covered nanoarray is a unique substrate for SERS to give Raman bands of immune reagents and to indicate the immunoreactions at higher sensitivity.

1. A surface-enhanced Raman spectroscopy (SERS)—active structure for use in Raman scattering detection, the structure comprising:
a substrate,
an array of nanostructures on the substrate, and
a coating of metal nanoparticles covering the nanostructures.

2. The SERS—active structure of claim 1 wherein the substrate is a material selected from the group consisting of elemental and compound semiconductors and their complex compounds, including carbon, diamond, Si, Ge, ZnO, ZnS, ZnSe, CdS, CdSe, BN, AlN, GaN, InP, GaAs, and SiC.

3. The SERS—active structure of claim 1 wherein the nanostructures comprise at least one of nanowires, nanorods, nanoribbons, nanotubes, nanochains, and nanocables.

4. The SERS—active structure of claim 3 wherein the nanostructures are formed on the substrate by deposition and chemical etching.

5. The SERS—active structure of claim 3 wherein the nanostructures are a material selected from the group consisting of inorganic and organic semiconductors, conductors, insulators, molecules, polymers and bio-molecules.

6. The SERS—active structure of claim 1 wherein the array of nanostructures is an ordered array.

7. The SERS—active structure of claim 1 wherein the metal nanoparticles comprise a material selected from the group consisting of Au, Ag, Cu, Fe, Co, Ni, Ru, Rh, Pd, Pt and their composites.

8. The SERS—active structure of claim 7 wherein the metal nanoparticles are grown on the nanostructures.
